(19) United States
(12) Patent Application Publication
(10) Pub. No.: US 2019/0047474 A1
(43) Pub. Date: Feb. 14, 2019

(54) VIEWING DEVICE FOR VEHICLE

(71) Applicant: KABUSHIKI KAISHA TOKAI-RIKA-DENKI-SEISAKUSHO, Aichi (JP)

(72) Inventors: Hiroto ASAI, Aichi (JP); Masakazu IWATSUKI, Aichi (JP); Shigeki YOSHIDA, Aichi (JP)

(21) Appl. No.: 16/085,819

(22) PCT Filed: Feb. 27, 2017
(86) PCT No.: PCT/JP2017/007475

§ 371 Date: Sep. 17, 2018

(30) Foreign Application Priority Data
Mar. 24, 2016 (JP) 2016-060444

(51) Int. Cl. B60R 1/074; B60R 1/078

(52) U.S. Cl. CPC B60R 1/074; B60R 1/078

(57) ABSTRACT

A door mirror device for a vehicle has a mirror base that is fixed to a vehicle body side and that has a mirror base side screw portion. Further, the door mirror device for a vehicle has a stand that has a rotating shaft portion around whose axis is rotated a mirror supporting portion that supports a mirror, and a stand side screw portion that is engaged with the mirror base side screw portion. Further, the stand is fixed to the mirror base in a state in which the mirror base side screw portion and the stand side screw portion are engaged.

### TECHNICAL FIELD

The present invention relates to a viewing device for a vehicle.

### BACKGROUND ART

An outer mirror for a vehicle, which is a viewing device for a vehicle that makes it possible for the rear side of the vehicle to be seen from the driver's seat, is disclosed in International Publication No. 2006/038274. This outer mirror for a vehicle is structured to include a mirror base that is mounted to a side portion of the vehicle, and a stand (a shaft) that is fixed to the mirror base via a screw.

By the way, in a structure in which a mirror base and a stand are fixed via a screw that is a member separate from the mirror base and the stand, portions that the screw is inserted-through or screwed-together with (insert-through holes or screw holes) must be formed in the mirror base and the shaft, and it is difficult to devise compactness of the fixed portion of the mirror base and the stand.

### SUMMARY OF INVENTION

### Technical Problem

In view of the above-described circumstances, an object of the present invention is to provide a viewing device for a vehicle that can devise compactness of the fixed portion of a base and a stand.

### Solution to Problem

A viewing device for a vehicle of a first aspect of the present disclosure comprises: a base that is fixed to a vehicle body side and that has a base side engaging portion; and a stand that has a rotating shaft portion around whose axis is rotated a supporting portion that supports a viewing portion that assists viewing by a vehicle occupant, and a stand side engaging portion that is engaged with the base side engaging portion, the stand being fixed to the base in a state in which the base side engaging portion and the stand side engaging portion are engaged.

In a viewing device for a vehicle of a second aspect of the present disclosure, in the viewing device for a vehicle of the first aspect, the base side engaging portion and the stand side engaging portion are a base side screw portion and a stand side screw portion, respectively.

In a viewing device for a vehicle of a third aspect of the present disclosure, in the viewing device for a vehicle of the second aspect, a side of the stand, which side is opposite the rotating shaft portion, has intersecting surfaces that intersect a peripheral direction of the stand side screw portion.

### Advantageous Effects of Invention

In accordance with the viewing device for a vehicle of the first aspect of the present disclosure, the viewing device for a vehicle is fixed to the vehicle body side due to the base being fixed to the vehicle body side. Further, the supporting portion can be displaced due to the supporting portion, which supports the viewing portion, being rotated around the axis of the rotating shaft portion. Here, in the first aspect of the present disclosure, the stand is fixed to the base due to the base side engaging portion that is provided at the base and the stand side engaging portion that is provided at the stand being engaged. In this way, in the first aspect of the present disclosure, the stand can be fixed to the base without using a fastening member for fixing the stand to the base. Due thereto, there is no need to provide a space for disposing the aforementioned fastening member at the fixed portion of the stand and the base, and compactness of the fixed portion of the stand and the base can be devised.

In accordance with the viewing device for a vehicle of the second aspect of the present disclosure, due to the stand being rotated, the stand side screw portion of the stand and the base side screw portion of the base can be engaged. Due thereto, the stand can be fixed to the base easily.

In accordance with the viewing device for a vehicle of the third aspect of the present disclosure, the stand side screw portion of the stand and the base side screw portion of the base can be screwed-together by causing a tool to engage with the intersecting surfaces of the stand and rotating the tool. Due thereto, the stand can be fixed to the base easily.

### BRIEF DESCRIPTION OF DRAWINGS

FIG. 1 is a front view showing a door mirror device for a vehicle.

FIG. 2 is an exploded perspective view showing a mirror base and a stand.

FIG. 3(1) is a front view showing the mirror base and the stand, (2) is a rear view showing the mirror base and the stand seen from the direction opposite (1), (3) is a cross-sectional view showing the cross-section of the mirror base and the stand cut along line 3C-3C shown in (2), and (4) is a bottom view showing the mirror base and the stand.

FIG. 4 is an explanatory drawing for explaining the processes of fixing the stand to the mirror base, and (1) shows a state before a rotating shaft portion of the stand is inserted through a tubular portion that is formed at the mirror base, (2) shows a process of inserting the rotating shaft portion of the stand through the tubular portion formed in the mirror base, and (3) shows a state in which a stand side screw portion that is formed at the stand is screwed-together with a mirror base side screw portion that is formed at the mirror base.

### DESCRIPTION OF EMBODIMENTS

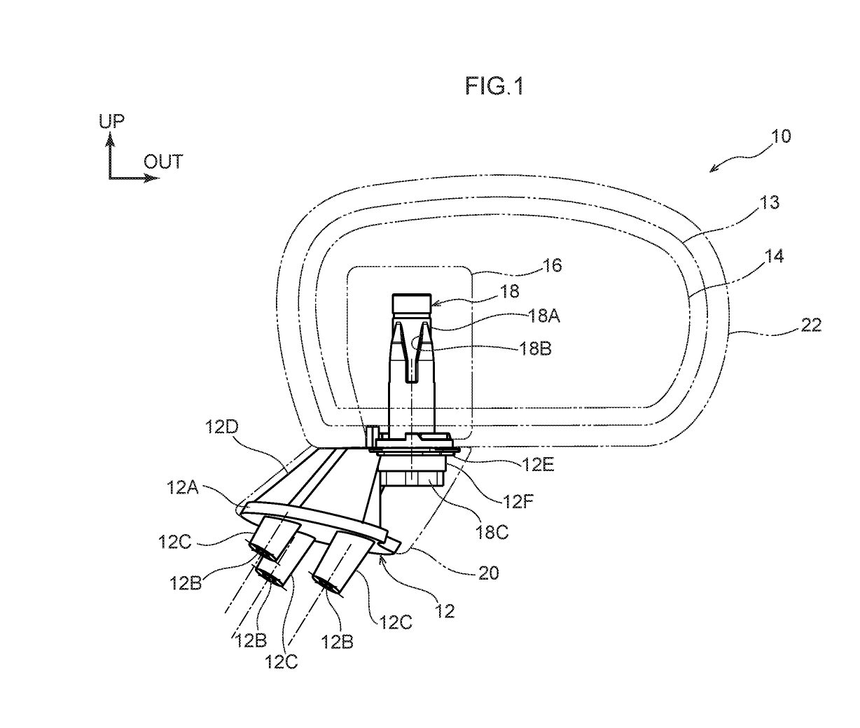

As shown in FIG. 1, a door mirror device 10 for a vehicle, which serves as a viewing device for a vehicle relating to an embodiment of the present invention, is a structure that, by being mounted to a side door that structures a portion of a vehicle body, makes it possible for a vehicle rear side to be seen from a driver's seat. Note that the vehicle longitudinal direction forward side is denoted by arrow FR, the vehicle transverse direction outer side is denoted by arrow OUT, and the vehicle vertical direction upper side is denoted by arrow UP. Further, in the following description, when merely longitudinal and vertical directions are used, they refer to the longitudinal of the vehicle longitudinal direction and the vertical of the vehicle vertical direction.

The door mirror device 10 for a vehicle is structured to include a mirror base 12 that is fixed to a side door, and a stand 18 that, via a retracting device 16, rotatably supports a mirror supporting portion 14 that serves as a supporting portion that supports a mirror 13 that serves as a viewing portion.

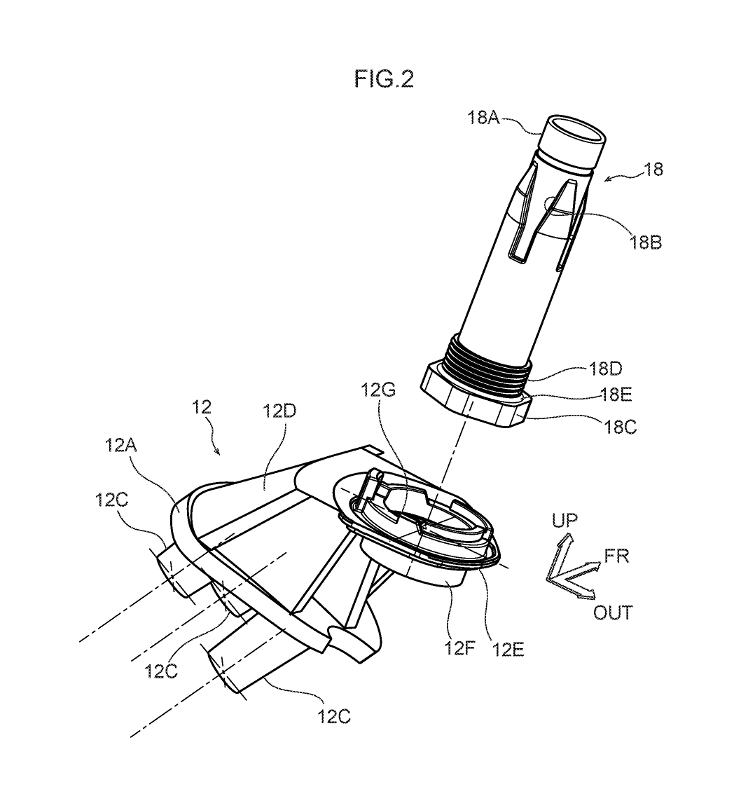

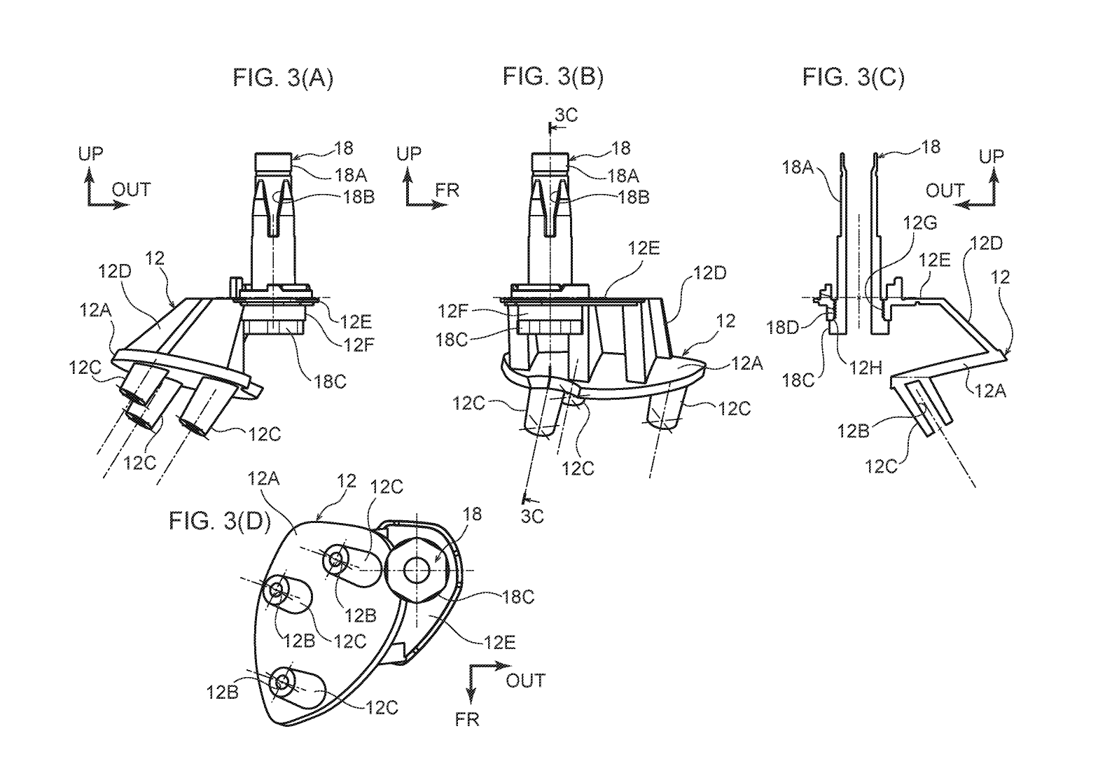

As shown in FIG. 2 and (1) to (4) of FIG. 3, the mirror base 12 is formed by using a metal material such as an aluminum alloy or the like. This mirror base 12 has a proximal wall portion 12A that is plate-shaped and is disposed along the side door, and three boss portions 12C that project-out toward a vehicle obliquely lower side from the proximal wall portion 12A and that have screw holes 12B with which are screwed bolts for fixing the mirror base 12 to the side door. Further, the mirror base 12 has a mirror base main body portion 12D that projects-out toward a vehicle obliquely upper side from the proximal wall portion 12A, and a stand fixing portion 12E that extends toward the vehicle transverse direction outer side from the upper end portion of the mirror base main body portion 12D and that is fixed to the stand 18 that is described later.

As shown in FIG. 2 and (3) of FIG. 3, a tubular portion 12F, which is formed in the shape of a tube whose axial direction is the vertical direction and through which a portion of the stand 18 is inserted, is provided at the stand fixing portion 12E. A mirror base side screw portion 12G that serves as a mirror base side engaging portion is formed, with the axial direction thereof being the vertical direction, at the lower side of the inner peripheral portion of the tubular portion 12F. Note that this mirror base side screw portion 12G is a female screw portion. Further, the diameter of an end portion 12H, which is at the lower side of the inner peripheral portion of the tubular portion 12F, gradually increases toward the lower side. Due thereto, the end portion 12H at the lower side of the inner peripheral portion of the tubular portion 12F is curved gently. Note that the above-described mirror base 12 is covered by a mirror base cover 20.

The stand 18 is formed by using a metal material such as an aluminum alloy or the like, in the same way as the mirror base 12. This stand 18 is formed in the shape of a tube whose axial direction is the vertical direction. Further, the stand 18 has a rotating shaft portion 18A with which is engaged the retracting device 16 (see FIG. 1) that is mounted to the mirror supporting portion 14. Note that the axial direction of the rotating shaft portion 18A (the axial direction of the stand 18) coincides with the vertical direction of the vehicle. Plural anchor grooves 18B at which a portion of the retracting device 16 is anchored are formed in the rotating shaft portion 18A along the axial direction. Further, the lower side end portion of the stand 18 is a tool engaging portion 18C that is formed in a substantially hexagonal shape that has six intersecting surfaces that intersect the peripheral direction of a stand side screw portion 18D. The shape of the outer peripheral surface of this tool engaging portion 18C is a shape that is such that a socket wrench, which is a tool for rotating hexagonal nuts and bolts, can engage therewith. Moreover, the stand side screw portion 18D that serves as a stand side engaging portion is formed, with the axial direction thereof being the vertical direction, at the outer peripheral portion of the region, which is between the rotating shaft portion 18A and the tool engaging portion 18C at the stand 18. Note that the stand side screw portion 18D is a male screw portion. Further, the diameter of a border portion 18E of the stand side screw portion 18D and the tool engaging portion 18C at the stand 18 gradually increases toward the lower side. Due thereto, the border portion 18E of the stand side screw portion 18D and the tool engaging portion 18C at the stand 18 is gently curved. The above-described stand 18 is, together with the retracting device 16 and the mirror supporting portion 14, covered by an outer mirror cover 22.

The processes of fixing the stand 18 to the mirror base 12 are described next.

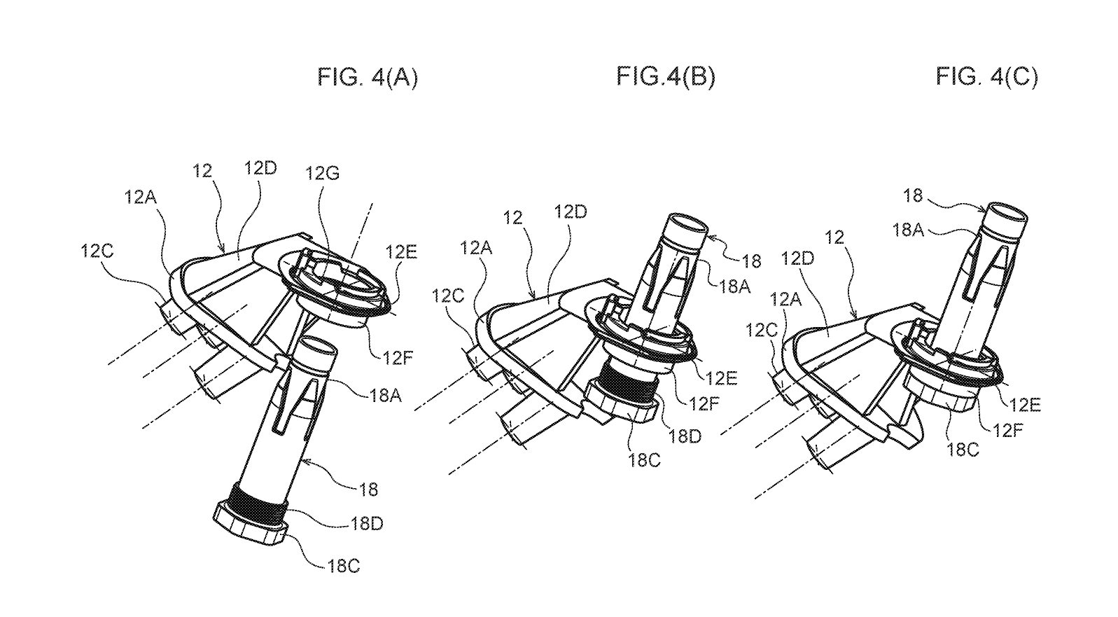

As shown in (1) and (2) of FIG. 4, first, the rotating shaft portion 18A of the stand 18 is inserted-through the tubular portion 12F of the mirror base 12. Next, the stand 18 is rotated via the socket wrench that is engaged with the tool engaging portion 18C of the stand 18. Due thereto, the stand side screw portion 18D of the stand 18 and the mirror base side screw portion 12G of the mirror base 12 are screwed-together. Then, as shown in (3) of FIG. 4, in the state in which the tool engaging portion 18C of the stand 18 is made to abut the tubular portion 12F of the mirror base 12, by applying a predetermined torque to the stand 18, the stand 18 is fixed to the mirror base 12 in a state in which the end portion 12H, which is at the lower side of the inner peripheral portion of the tubular portion 12F of the mirror base 12, and the border portion 18E of the stand side screw portion 18D and the tool engaging portion 18C at the stand 18, are fit tightly to one another.

Note that a loosening preventing material which suppresses loosening of the screw may be interposed between the stand side screw portion 18D of the stand 18 and the mirror base side screw portion 12G of the mirror base 12.

(Operation and Effects of Present Embodiment)

Operation and effects of the present embodiment are described next.

As shown in FIG. 1, in accordance with the door mirror device 10 for a vehicle of the present embodiment, due to unillustrated bolts being screwed-into the boss portions 12C of the mirror base 12, the mirror base 12 is fixed to the side door. Due thereto, the door mirror device 10 for a vehicle is fixed to the side door.

Further, due to the retracting device 16 being operated, and the mirror supporting portion 14 that supports the mirror 13 being rotated together with the retracting device around the axis of the rotating shaft portion 18A of the stand 18, the mirror supporting portion 14 can be displaced between an unfolded position and a retracted position.

Here, in the present embodiment, the stand 18 is fixed to the mirror base 12 due to the mirror base side screw portion 12G of the mirror base 12 and the stand side screw portion 18D of the stand 18 being engaged. In this way, in the present embodiment, the stand 18 can be fixed to the mirror base 12 without using a fastening member for fixing the stand 18 to the mirror base 12. Due thereto, there is no need to provide a space where the aforementioned fastening member is to be disposed at the fixed portion of the stand 18 and the mirror base 12, and compactness of the fixed portion of the stand 18 and the mirror base 12 (the mirror base side screw portion 12G of the mirror base 12 and the peripheral edge portion of the stand side screw portion 18D of the stand 18) can be devised.

Further, in the present embodiment, by rotating the stand 18, the stand side screw portion 18D of the stand 18 and the mirror base side screw portion 12G of the mirror base 12 can be screwed-together. Due thereto, the stand 18 can be easily fixed to the mirror base 12. In addition, in the present embodiment, by providing the tool engaging portion 18C, with which a socket wrench can engage, at the stand 18, the stand 18 can be easily rotated via the socket wrench.

Moreover, in the present embodiment, by making the end portion 12H, which is at the lower side of the inner peripheral portion of the tubular portion 12F of the mirror base 12, and the border portion 18E of the stand side screw portion 18D and the tool engaging portion 18C at the stand 18, be structures that are gently curved, stress arising at the contacting portions of the both and the peripheral edge portions thereof can be mitigated.

Further, in the present embodiment, by making the stand 18 and the mirror base 12 be structured by separate bodies, the stand 18 can be formed and uniformizing of the wall thickness of the stand 18 can be devised, without being affected by the direction of pulling-out of the mold that forms the mirror base 12. Further, in a structure in which the stand 18 and the mirror base 12 are formed integrally by casting, it is easy for a free solidification surface to be formed at the border portion between the stand 18 and the mirror base 12. However, in the present embodiment, by making the stand 18 and the mirror base 12 be structured by separate bodies, a free solidification surface forming at the border portion of the stand 18 and the mirror base 12 can be avoided or suppressed.

Note that, in the present embodiment, an example is described in which the stand 18 is fixed to the mirror base 12 due to the stand side screw portion 18D of the stand 18 and the mirror base side screw portion 12G of the mirror base 12 being screwed-together, but the present invention is not limited to this. For example, the stand 18 may be fixed to the mirror base 12 by a structure in which the region, at which the stand side screw portion 18D is formed, of the stand 18 and the region, at which the mirror base side screw portion 12G is formed, of the mirror base 12 being press-fit together. Further, in a case in which the stand 18 and the mirror base 12 are formed by using resin materials, the stand 18 may be fixed to the mirror base 12 by joining the both by welding or the like.

Further, in the present embodiment, an example is described in which the present invention is applied to the door mirror device 10 for a vehicle that is fixed to a side door, but the present invention is not limited to this. For example, the present invention can also be applied to a fender mirror or a fender outer mirror or the like that serves as a viewing device for a vehicle and is mounted to the fender of the vehicle body. Further, the present invention may be applied to a viewing device for a vehicle that includes a camera as the viewing portion instead of the mirror 13.

Although an embodiment of the present invention has been described above, the present invention is not limited to the above, and, of course, can be implemented by being modified in various ways other than the above within a scope that does not depart from the gist thereof.

The disclosure of Japanese Patent Application No. 2016-60444 filed on Mar. 24, 2016 is, in its entirety, incorporated by reference into the present specification.

1. A viewing device for a vehicle, comprising:
a base that is fixed to a vehicle body side and that includes a base side engaging portion; and
a stand that includes a rotating shaft portion around whose axis is rotated a supporting portion that supports a viewing portion that assists viewing by a vehicle occupant, and a stand side engaging portion that is engaged with the base side engaging portion, the stand being fixed to the base in a state in which the base side engaging portion and the stand side engaging portion are engaged.

2. The viewing device for a vehicle of claim 1, wherein the base side engaging portion and the stand side engaging portion are a base side screw portion and a stand side screw portion, respectively.

3. The viewing device for a vehicle of claim 2, wherein a side of the stand, which side is opposite the rotating shaft portion, has intersecting surfaces that intersect a peripheral direction of the stand side screw portion.

4. The viewing device for a vehicle of claim 2, wherein a lower side end portion of the stand is a tool engaging portion that is formed in a substantially hexagonal shape having six intersecting surfaces that intersect a peripheral direction of the stand side screw portion.

5. The viewing device for a vehicle of claim 4, wherein the stand side screw portion is formed, with a vertical direction being an axial direction thereof, at an outer peripheral portion of a region, which is between the rotating shaft portion and the tool engaging portion, of the stand.

6. The viewing device for a vehicle of claim 5, wherein the stand side screw portion is a male screw portion.
